(19) United States
(12) Patent Application Publication
(10) Pub. No.: US 2008/0231712 A1
(43) Pub. Date: Sep. 25, 2008

(54) Portable video acquisition and internet broadcast system

(75) Inventors: Bentley D. Frink, Wrightsville Beach, NC (US); William J. Mason, Wrightsville Beach, NC (US); George H. McEachem, Wrightsville Beach, NC (US)

Correspondence Address: WILLIAM J. MASON;MACCORD MASON PLLC, POST OFFICE BOX 1489, WRIGHTSVILLE BEACH, NC, 28480, US

(73) Assignee: Property Monitors, Inc.

(21) Appl. No.: 12/077,217

(22) Filed: Mar. 18, 2008

Related U.S. Application Data
(60) Provisional application No. 60/919,438, filed on Mar. 22, 2007.

(51) Int. Cl. H04N 5/225

(52) U.S. Cl. 348/207.1; 348/E05.024

(57) ABSTRACT

A camera used to acquire video images at the remote site having a means for acquiring a video image, a wireless transceiver for transmitting the video images to a wireless Internet router. The camera includes a built-in web server for serving the images over the Internet to client computers having standard Internet web browsers. Moreover, the camera further includes an enclosure supporting the image acquisition means and web server hardware, a battery in a circuit with the camera, a hand operated switch adapted to close the circuit, and a handgrip for use by an operator in carrying the camera.

This application claims priority to U.S. Provisional Application No. 60/919,438, filed on Mar. 22, 2007, which is incorporated herein by reference.

### FIELD OF THE INVENTION

The present invention relates to a portable IP network camera, and in particular to a system incorporating the portable IP network camera that enables the acquisition of video images at a site for viewing via the Internet. The system is especially useful in enabling one individual to acquire video images at a site, while other individuals can view the live images at one or more remote locations via computer screens displaying the images. The invention also contemplates archiving of the acquired video images on a remote web server for later viewing at times selected by the viewer.

### SUMMARY OF THE INVENTION

Generally, the camera used to acquire video images at the remote site is comprised of a means for acquiring a video image, a wireless transceiver for transmitting the video images to a wireless Internet router, a built-in web server for serving the images over the Internet to client computers having standard Internet web browsers; and an enclosure supporting the image acquisition means and web server hardware, a battery in a circuit with the camera, a hand operated switch adapted to close the circuit, and a handgrip for use by an operator in carrying the camera. Preferably, the camera also includes an audio microphone to capture audio occurring at the remote site. The captured audio is streamed by the built-in web server along with corresponding video over a local area network and preferably over the Internet to client computers having multimedia outputs. At present, captured audio and video can be streamed over the Internet using the MPEG-4 multimedia streaming format. A motion JPEG streaming format is preferred if only a video stream is needed. Preferably, the camera also includes at least one audio speaker and audio amplifier in communication with the built-in for receiving and reproducing audio transmitted from client computers for two way audio communication over the Internet.

The built-in web server software includes code for making HTML pages customizable. This feature allows a user to embed video from the camera directly into a web page having context for video being displayed. For example, a real estate agent showing a home would typically want to include text on the web page to describe the home along with its list price, etc. Moreover, the built-in web server software also includes code to interface with video recording software that can be installed on a client or server computer.

The camera can be constructed from an existing stationary IP network camera that includes the image acquisition means and web server in electrical communication with a radio frequency transceiver within a first housing, by supporting the first housing on a second housing that encloses the battery in a circuit with the camera. At least one antenna in electrical communication with the transceiver extends from the first housing. The handgrip can be integral with the second housing, while the hand operated switch can be a trigger type switch accessible from the handgrip. Alternatively, the circuit boards, antennas, lens and other components of the network camera can be directly supported by the same housing that encloses the battery.

Suitable wireless IP cameras for the present system are the Axis 207W and the Axis 207MW. The Axis 207MW can transmit up to 12 frames of video per second at an image resolution of 1.3 Megapixels. On the other hand, the Axis 207W transmits VGA resolution video at up to 30 frames per second. The lens of the Axis 207W is 4.0 mm, F2.0 with a horizontal viewing angle of 55 degrees. Alternately, the Axis 207MW lens is 3.6 mm, F1.8 with a horizontal viewing angle of 85 degrees. Both lenses have a fixed iris and a focal range of 0.5 m to infinity.

The wireless interface for either camera complies with the IEEE 802.11g standard, thus giving a wireless transmission rate of between 6 and 54 Mbps. Moreover, both cameras include a built-in microphone for one-way audio. Audio compression is achieved using the G.711 PCM standard that allows audio transmission of up to 64 kbits/s.

The camera can also include a light source, such as an LED or halogen light source that is directed to the front of the camera, with the light source being in a circuit with the battery and a switch to close the circuit to the light source. For example, the light source can be in the circuit with the camera switch and a separate light switch, so that the light source is illuminated when the light switch and the camera switch are closed.

The camera can also include an electronic display screen directed toward the rear of the camera, with the screen being fed an image from the network camera image acquisition means, or by a separate analog camera module directed toward the front of the camera. The electronic display screen image is preferably sized to correspond to the image to be viewed on computer screens at remote locations. The electronic display screen can be any type useable for displaying video. Such screens can be, but are not limited to the liquid crystal display (LCD) and the organic light emitting diode (OLED) types.

The camera enclosure can also include a tripod mount or other means for temporarily mounting the camera in an unattended stationary mode. A trigger lock for the camera switch is included in the handle for keeping the camera circuit activated while the camera is in the unattended stationary mode.

A wireless router connected to the Internet via cable or dsl can be located at the image acquisition site. Normally, the router will have an access encryption mode, such as a WEP or WPA access code to prevent unauthorized access to the Internet via the router. The network camera is programmable with the router access code so that video images acquired by the camera can be transmitted via the router. In this embodiment, the camera will typically communicate through a LAN to the Internet via router port forwarding. Another embodiment of the invention contemplates connection of the camera web server to a wireless broadband PC card carried by the camera enclosure so that images can be transmitted via the cellular network.

The present invention is particularly useful in acquiring video images at a plurality of geographically dispersed sites, with an Internet connected wireless router being located at each of the sites. In order to enable use of a single camera as described above at all sites, the multiple routers may use a common access code, with the camera being programmed with that access code. Alternatively, the camera can be programmed with different access codes for different sites, with the camera including selector means for selecting the appropriate access code.

Video images acquired by the camera are streamed via the Internet for live images on computer screens. The images can also be transmitted to a remote web server that includes means for archiving video images. For example, video images can be stored in separate files with each file containing video images acquired from the time the camera is switched on until the camera is switched off. Thus, the user can release the trigger to temporarily interrupt filming without starting a new file.

The remote web server can also include means for online editing of video images, thereby enabling the user to store and edit images online without the necessity of storing the images on disc or other storage in the camera, loading the images into a computer for editing, and then uploading the edited images. All storage and editing can be done online.

One use contemplated for the present invention is the monitoring of one or more construction sites, in particular home construction sites, enabling the builder, home owner, architect, and other interested parties to view activities at the site without the need to be physically present at the site. Instead, a foreman or other worker at the construction site can walk about the construction site, both outside and inside the building, filming area of interest. Acquired images are transmitted from the camera server via the site's router for streaming to viewers, and optionally to a remote server for archiving.

As the worker uses the present portable video acquisition system to acquire video images of the site, the builder and/or other interested parties view their computer screens connected via a web browser to the Internet, watching live images of the imaged site. If desired, the viewing parties can be connected to each other and/or the worker to discuss the site via the telephone or other means such as a Skype conference call. For example, if there is a change required in construction, the immediate agreement of all parties, the builder, the homeowner, the architect, etc., can be obtained, even if the parties are located in different states.

Other applications of the system are also contemplated. For example, a child's birthday party or other event can be filmed by one parent while the other parent at some distant location, e.g., Iraq, can watch the event live. A school sporting event, such as a little league ball game can be filmed for live or delayed viewing, extending the entertainment experience to sporting activities where filming by current technology is cost prohibitive.

### BRIEF DESCRIPTION OF THE DRAWINGS

FIG. 1 is a sectional side view of a first embodiment of a portable network camera.

FIG. 2 is a sectional side view of a second embodiment of a portable network camera.

FIG. 3 is a schematic view of the image acquisition system.

### DETAILED DESCRIPTION OF THE INVENTION

In the following description, terms such as horizontal, upright, vertical, above, below, beneath, and the like, are used solely for the purpose of clarity in illustrating the invention, and should not be taken as words of limitation. The drawings are for the purpose of illustrating the invention and are not intended to be to scale.

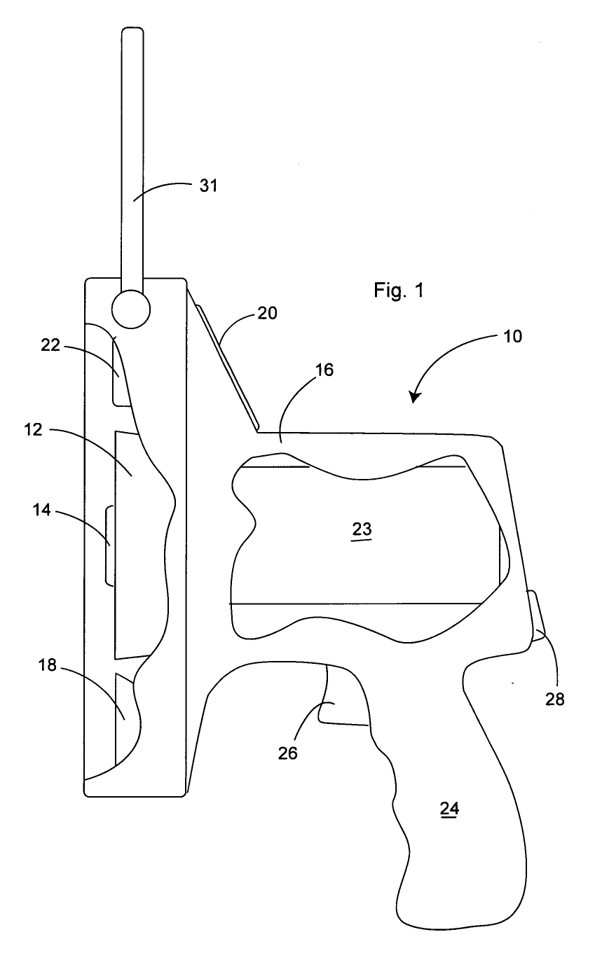

As illustrated in FIG. 1, one embodiment of a portable network camera, generally 10, is comprised of a first enclosure 12 enclosing a lens 14 and circuitry for image processing and a web server, not shown. Enclosure 12 is supported within a larger handheld enclosure 16, which also supports a light source 18, an LCD viewing screen 20, an analog camera 22 to feed an image to screen 20, and a rechargeable electrical battery 23 in circuit with the image processor and web server, light source 18, and camera 22. Enclosure 16 also include a handgrip 24, a trigger 26 for activating the camera, and an on/off switch 28.

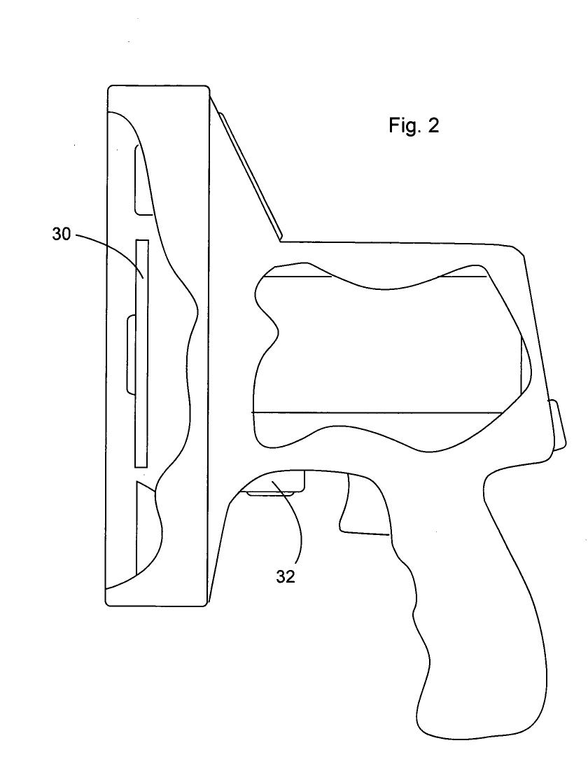

FIG. 2 illustrates a modification of the embodiment of FIG. 1, in which enclosure 12 is omitted and a circuit board 30 carrying the image processor and web server is mounted directly within enclosure 16. An antenna 31 is in communication with a radio frequency transceiver 33 in communication with circuit board 30. Radio frequency transceiver 33 can be a short range (100 m) 802.11G transceiver if a wireless LAN router is within range or transceiver 33 can be broadband cellular modem that is usable with cellular carriers such as Verizon™ or AT&T™. Circuit board 30 also includes a battery charger and voltage regulator circuit 35 that is usable to charge electrical battery 23. The embodiment of FIG. 2 also includes a tripod mount 32 for stationarily supporting camera 10.

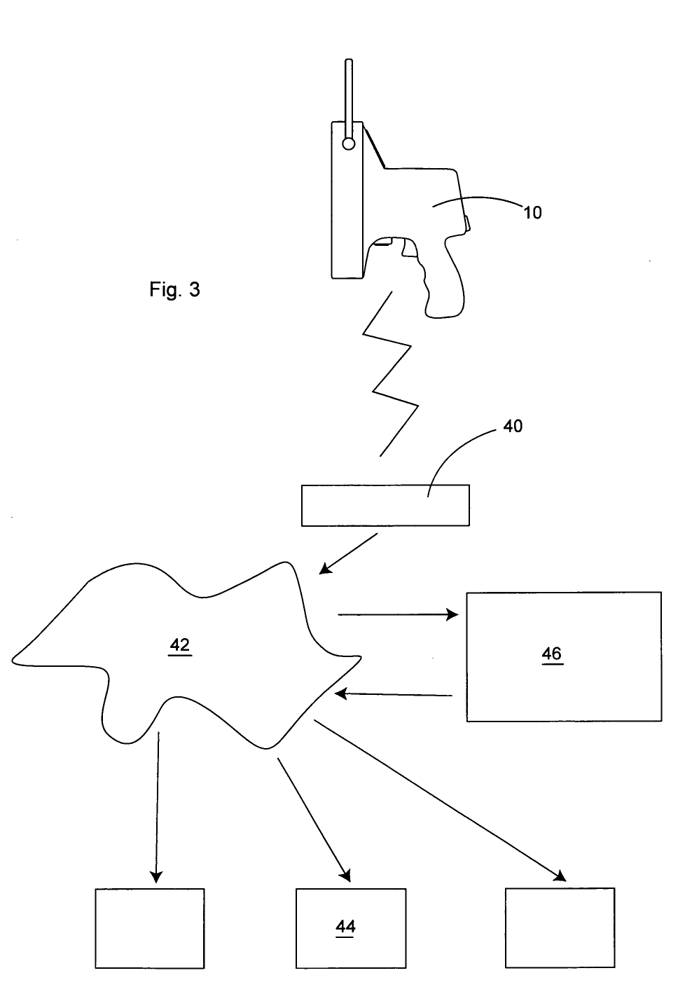

FIG. 3 is a schematic illustration of the system in which camera 10, located at a site, e.g., a construction site, wirelessly transmits acquired video images to a wireless router 40 located at the site. Router 40 then streams the video images via the Internet 42 to one or more client computers 44 for live viewing. Images can also be transmitted to a remote web server 46 for archiving and editing.

Certain modifications and improvements will occur to those skilled in the art upon a reading of the foregoing description. It should be understood that all such modifications and improvements are properly within the scope of the invention.

What is claimed is:

1. A portable network camera comprising:
a) means for acquiring a video image;
b) a web server for wirelessly transmitting the image via the Internet; and
c) a battery in a circuit the video image acquisition means and the server;
d) a hand operated switch adapted to close said circuit; and
e) an enclosure enclosing said image acquisition means, said web server and said battery, said enclosure including a handgrip for use by an operator in carrying said system.

2. The camera of claim 1 further including a wireless broadband access card in communication with said camera.

3. The camera of claim 1, further including means for storing a plurality of wireless router access codes and for selecting from among said codes.

6. The camera of claim 3, wherein said access codes are WEP or WPA access code.

7. The camera of claim 1, further including an illumination means.

8. The camera of claim 1, wherein said switch is a trigger adjacent said handgrip.

9. The camera of claim 1, wherein said enclosure includes a tripod connection.

10. A system for acquiring video images at a plurality of geographically dispersed sites comprising:
a) a wireless router at each of said sites, each of said routers being connected to the Internet, said routers having a common access code;
b) a handheld portable camera including means for acquiring a video image and a web server for wirelessly transmitting the image to the Internet; a battery and hand operated switch in circuit with said camera, and an enclosure with a handgrip for use by an operator in carrying said system, said camera being programmable with said common access code.

11. A system for acquiring and displaying video images from a site comprising:
a) a wireless router at said site connected to the Internet, said router having an access code;
b) a handheld portable camera including means for acquiring a video image and a web server for wirelessly transmitting the image to the Internet via the router, a battery and hand operated switch in circuit with said camera, and an enclosure with a handgrip for use by an operator in carrying said system, said camera being programmable with said access code;
c) a web server for receiving video images transmitted from said camera, said server being capable of storing said video images for later display.

12. A system for acquiring and displaying video images from a plurality of geographically dispersed sites comprising:
a) a wireless router at each of said sites connected to the Internet, said router having an access code;
b) a handheld portable camera including means for acquiring a video image and a web server for wirelessly transmitting the image to the Internet via the router, a battery and hand operated switch in circuit with said camera, and an enclosure with a handgrip for use by an operator in carrying said system, said camera being programmable with the access code of each of said sites; and
c) a web server for receiving video images transmitted by said camera for each of said sites, said server being capable of streaming said images to a web browser and storing said video images for later display.

13. The system of claim 12, wherein said sites have a common router access code.

14. The system of claim 12, wherein said sites have routers with different access codes, and said camera is programmed with the access codes of all of the sites, with means for selecting any one of said codes.

15. The system of claim 12, wherein said video images are stored in multiple files, each file including video images received from the time the camera circuit is closed until the camera circuit if opened.

16. The system of claim 12, wherein said server including software for editing stored video images.
